(19) United States
(12) Patent Application Publication
(10) Pub. No.: US 2023/0278709 A1
(43) Pub. Date: Sep. 7, 2023

(54) VEHICLE PORTION

(71) Applicant: VERTICAL AEROSPACE GROUP LIMITED, London (GB)

(72) Inventors: Alistair WYATT, London (GB); James PECK, London (GB)

(73) Assignee: VERTICAL AEROSPACE GROUP LIMITED, London (GB)

(21) Appl. No.: 18/010,332

(22) PCT Filed: Jun. 24, 2021
(86) PCT No.: PCT/GB2021/051611

§ 371 Date: Dec. 14, 2022

(30) Foreign Application Priority Data
Jun. 29, 2020 (GB) 2009868.7

(51) Int. Cl. B64D 11/06; B64C 27/52

(52) U.S. Cl. CPC B64D 11/0601; B64C 27/52

(57) ABSTRACT

A portion of a vehicle includes occupant zones in rows. First and second of the occupant zones are adjacent rows and the portion of the vehicle further includes access points arranged for user ingress into the vehicle. Each access point is located positionally asymmetric with all opposing access points of the portion. Further the access points include first and second access points located about the portion such that the direction of ingress through the first access point is substantially opposed to the direction of ingress through the second. The first occupant zone is the nearest to the first access point and the second occupant zone is the nearest to the second access point. The first occupant zone is to be preferentially accessed by user ingress from the first access point, and the second occupant zone is to be preferentially accessed by user ingress from the second access point.

### TECHNICAL FIELD

The present disclosure relates to a vehicle portion. Aspects relate to a portion of a vehicle, a vehicle and a method of user vehicle ingress. Embodiments may have particular application in aircraft and in particular aerial taxis, though this is not intended to be limiting. Indeed it will be appreciated that applications may be found across a diverse range of vehicle fields, especially where passengers are carried (e.g. motor vehicles, trains, trams, cable cars, funicular railways, monorails, lifts (e.g. lift gondolas) and rides.

### BACKGROUND

For the purposes of illustration the following background will be described in the context of aircraft ingress and egress. This is not however intended to be limiting.

Passenger embarkation and disembarkation is often subject to detailed choreography in the airline industry.

Often passengers embark from one side of the aircraft only. This can limit/prevent instances of passengers meeting in opposition and therefore reduce congestion and/or confusion. It may also allow a particular member of flight-crew (e.g. the pilot) to more easily monitor passenger embarkation. Structural advantages may also be achieved, i.e. reduced number of apertures in the fuselage. Nonetheless, there is still often confusion and delay even under normal (non-emergency) operating conditions. Additionally, at least in small aircraft where embarking passengers may be obliged to shuffle along a row, clash of body parts (e.g. heads) is a risk.

### SUMMARY OF THE INVENTION

According to a first aspect, there is provided a portion of a vehicle optionally comprising occupant zones in rows, wherein a first of the occupant zones and a second of the occupant zones are optionally adjacent rows and the portion of the vehicle further optionally comprises access points arranged for user ingress into the vehicle, wherein each access point is optionally located so as to be positionally asymmetric with all opposing access points of the portion, and where further the access points optionally comprise a first access point and a second access point optionally located about the portion such that optionally the direction of ingress through the first access point is substantially opposed to the direction of ingress through the second access point and optionally the first occupant zone is the nearest occupant zone to the first access point and the second occupant zone is the nearest occupant zone to the second access point and where further, the portion is optionally arranged for the first occupant zone to be preferentially accessed by user ingress from the first access point, and for the second occupant zone to be preferentially accessed by user ingress from the second access point.

The arrangement of the first aspect may allow users to board the vehicle from substantially opposite directions, optionally simultaneously, without confusion concerning the most appropriate location for the boarding users to occupy, without mutual hinderance in reaching that location and/or without significant wait time for later boarding passengers caused by the configuration of the vehicle. Specifically, by opposing access points (e.g. access points on opposite sides of the vehicle and facing in opposite directions) being at least partially positionally offset, user ingress from opposite directions may be less likely to give rise to direct opposition. Further, by each occupant zone having a corresponding access point from which it is preferentially accessed (e.g. due to proximity, alignment, obstacles etc), users may be more naturally and intuitively directed to the appropriate occupant zone given their ingress point. The arrangement may therefore allow for more efficient and/or safer ingress of users and/or may help users by guiding them as to appropriate ingress method and occupancy zone to be occupied. Once a user has accessed the relevant occupant zone, he/she may at least in general, remain there until egress from the vehicle is performed. During egress a user may use the same access point as was used during ingress. As will be appreciated, the first and second occupant zones may be arranged to accommodate/receive passengers (as for instance distinct from being arranged to receive an operator or operators of the vehicle such as a controller, pilot or driver). The users may be passengers.

The forming of the occupant zones in rows may mean that they are substantially aligned with respect to one another. The occupant zones may be formed in a column.

In some embodiments the first occupant zone is substantially positionally aligned with the first access point. This may provide an expedient mechanism of arranging the portion such that the first occupant zone is preferentially accessed by user ingress from the first access point and/or to intuitively guide the user and/or to reduce impediment to the user in accessing the first occupant zone. The second occupant zone may additionally or alternatively be substantially positionally aligned with the second access point.

In some embodiments the direction of ingress through the first access point is non-perpendicular with respect to a row direction of the first and second occupant zones. As will be appreciated, a non-perpendicular arrangement of ingress direction and row orientation may, at least to the extent that the occupant zones are demarcated by some form of barrier or seating provision, allow easier access to the end of the row that is the first occupant zone and therefore easier access to the first occupant zone itself. The direction of ingress through the second access point may additionally or alternatively be non-perpendicular with respect to the row direction of the first and second occupant zones.

In some embodiments the direction of ingress through the first access point is substantially parallel to a row direction of the first and second occupant zones. This arrangement may further ease access to the end of the row that is the first occupant zone and therefore ease access to the first occupant zone itself. The direction of ingress through the second access point may additionally or alternatively be substantially parallel to the row direction of the first and second occupant zones.

In some embodiments the first occupant zone and second occupant zone are positioned so that one is forward of the other in the vehicle. Thus, each row may be oriented in a substantially side to side manner with respect to the vehicle e.g. in a direction that is substantially perpendicular to a conventional direction of travel of the vehicle during conventional flight. This may be a convenient layout for accessing the occupant zones, especially where the first and second access points are to the sides of the vehicle.

In some embodiments the first occupant zone and the second occupant zone are of substantially the same configuration. The first and second occupant zones may for instance be of the same or similar size and/or shape and/or layout/configuration. It may be for instance that the first and second occupant zones have the same or a similar quantity and type of furniture. Such arrangements may afford occupants of the first and second occupant zones similar conditions and may complement the positionally asymmetric access point layout in terms of ease of access to each of the first and second occupant zones. The first and second occupant zones may be arranged to each accommodate at least two users.

In some embodiments the first occupant zone comprises a seating area. The seating area may for instance comprise one or more seats and/or benches. The second occupant zone may additionally or alternatively comprise a seating area. The seating area of the first occupant zone may be aligned with the seating area of the second occupant zone. Thus, the seating areas of occupant zones may be aligned across the occupant zones. Each seating area of each occupant zone may comprise at least two seats.

In some embodiments seating in the first occupant zone is configured to face seating in the second occupant zone and the seating in the second occupant zone is configured to face the seating in the first occupant zone. That is seating in the first occupant zone may be configured to face the opposite direction to seating in the second occupant zone and vice versa. This configuration may be desirable in particular vehicles, but may also be more prone to user confusion/delay in selecting the most appropriate seat/seating to access where ingress of users is from two opposing directions. The positionally asymmetric access points of the present disclosure may therefore be advantageous where this seating configuration is used. It is further noted that all seating in the first occupant zone may be configured to face in the opposite direction to all seating in the second occupant zone (i.e. all seating in the first occupant zone is configured to face all seating in the second occupant zone).

In some embodiments seating in the first and the second occupant zones is configured to face in the same direction. In this case, the combination of the seating and the positionally asymmetric access points may present at least an impediment or even at least a significant impediment to users accessing the one of the first and the second occupant zone not preferentially accessed via the relevant first or second access point.

In some embodiments an emergency egress facility is provided substantially opposite the first access point. This may mean that occupants of the first occupant zone may have at least two and/or an additional potential egress route. This may be particularly appropriate where access to the second access point is at least somewhat hindered (e.g. by seating of the first occupant zone). The emergency egress facility may for instance be a window arranged to be popped-out. An emergency egress facility may be additionally or alternatively provided substantially opposite the second access point. As will be appreciated, in some embodiments both the fist and second access points may (e.g. in dependence on the arrangement of any seating) be ultimately readily accessible to occupants of both the first and second occupant zones, and therefore ultimately usable as egress points in emergencies or otherwise.

In some embodiments, the first and second access points are on opposite side walls of the vehicle. These side walls may be substantially parallel to the conventional direction of travel of the vehicle during conventional flight or may be oblique thereto. Alternatively however, the first and second access points may be on alternative substantially opposite walls of the vehicle respectively e.g. front and back walls.

In some embodiments the first access point may have restricted head height. That is, the height of the first access point may cause a significant proportion of people to stoop and/or crouch to some extent in order to obtain ingress. In such scenarios, it may be less easy than it might otherwise be for user’s to assess an appropriate occupant zone for them to access when entering the first access point. Further body part clash (e.g. head clash) may be more likely where user’s ingress from opposite directions. The second access point may additionally or alternatively have restricted head height.

In some embodiments the first access point comprises a door. The door may be of a gullwing design, which may be beneficial by comparison with other door arrangements in terms of reducing impediments to sight lines along the vehicle which might otherwise be advantageous in monitoring user ingress and/or egress from the vehicle via the first and/or the second access points. Nonetheless, in other embodiments, an alternative door arrangement may be utilised e.g. sliding, conventionally hinged or suicide. Additionally or alternatively the second access point comprises a door. Door configurations of the first and second access points may be the same or different.

In some embodiments the first and the second access points are the only access points arranged for user ingress of the portion.

In some embodiments the portion comprises all of the access points arranged for user ingress of the vehicle.

In some embodiments the portion comprises access points in addition to the first and second access points. The additional access points may adhere to the same principles as the first and second access points (i.e. are arranged for user ingress into the vehicle, are located so as to be positionally asymmetric with all opposing access points of the portion, are located about the portion such that the direction of ingress through each is substantially opposed to the direction of ingress through one of the first and second access points, are each associated with one of the occupant zones other than the first and second occupant zones and which forms part of a series of adjacent occupant zones including the first and second occupant zones, are each the nearest access point to their respective associated occupant zone and where the portion is arranged for the that respective associated occupant zone to be preferentially accessed by user ingress from the corresponding associated access point.

In some embodiments the portion defines an enclosed space in which the first and second occupant zones are provided. The portion may for instance be a cabin (e.g. a passenger) cabin. This cabin may be distinct (e.g. may be separated by a wall or bulkhead and optionally a door) from one or more other enclosed spaces of the vehicle (e.g. a cockpit).

In some embodiments the portion provides a common space in which the first and second occupant zones are provided. The portion may for example provide a single room in which the first and second occupant zones are located and there may be no separating walls or bulkheads between the first and second occupant zones.

In some embodiments the portion is substantially cuboid.

In some embodiments the vehicle comprises a vehicle operator zone.

In some embodiments the vehicle operator zone is centrally located within the vehicle with respect to a direction that is perpendicular to a conventional direction of travel of the vehicle during conventional flight. This may allow for easier monitoring of both sides of the vehicle and therefore supervision of ingress via the first and second access points where these are provided on opposite sides of the vehicle. The vehicle operator zone comprises a seat (e.g. a chair), which may itself be centrally located within the vehicle with respect to a direction that is perpendicular to a conventional direction of travel of the vehicle during conventional flight.

In some embodiments the vehicle is an aircraft. The vehicle may be an aerial taxi. The aircraft may be a vtol or stovl aircraft.

In some embodiments the aircraft may be arranged such that its propulsion is electrically powered. Specifically the vehicle may comprise one or more electrically powered propulsors (e.g. rotors and/or propellers). In some embodiments the one or more electrically powered propulsors are arranged to be static during user ingress and/or egress. This may be facilitated by the electrical nature of the power supply to the propulsors. Specifically, it may not be necessary/desirable to leave the propulsors rotating for a period on the ground to stabilise engine temperature and/or warm-up the engine again (as may be the case with some helicopters).

In some embodiments the aircraft is of a tilt rotor configuration.

According to a second aspect there is provided a vehicle comprising the portion according to the first aspect.

According to a third aspect there is provided a method of user vehicle ingress, the vehicle optionally comprising a portion of the vehicle optionally having occupant zones in rows, wherein a first of the occupant zones and a second of the occupant zones are optionally adjacent rows and the portion of the vehicle further optionally comprises access points arranged for user ingress into the vehicle, wherein each access point is optionally located so as to be positionally asymmetric with all opposing access points of the portion and where further the access points optionally comprise a first access point and a second access point, the method comprising:
i) optionally at least one first user ingress into the vehicle through the first access point optionally in a direction substantially opposed to a direction in which at least one second user would ingress the vehicle through the second access point; and
ii) optionally the at least one first user accessing the first occupant zone, which is optionally the nearest occupant zone to the first access point, rather than accessing the second occupant zone, which is optionally the nearest occupant zone to the second access point.

In some embodiments the method further comprises:
iii) at least one second user ingress into the vehicle through the second access point in a direction substantially opposed to the direction in which the at least one first user vehicle ingress through the first access point occurs; and
iv) the at least one second user accesses the second occupant zone, rather than accessing the first occupant zone.

In some embodiments the ingress of at least one of the at least one first user and the ingress of at least one of the at least one second user occurs substantially simultaneous.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1a is a starboard side view of part of a vehicle according to an embodiment of the invention;

FIG. 1b is cut-away top view of part of a vehicle according to an embodiment of the invention;

FIG. 1c is a port side view of part of a vehicle according to an embodiment of the invention;

FIG. 1d is cut-away top view of part of a vehicle according to an embodiment of the invention;

FIG. 2a is a starboard side view of part of a vehicle according to an embodiment of the invention;

FIG. 2b is cut-away top view of part of a vehicle according to an embodiment of the invention;

FIG. 2c is a port side view of part of a vehicle according to an embodiment of the invention;

FIG. 2d is cut-away top view of part of a vehicle according to an embodiment of the invention;

FIG. 3 is cut-away top view of part of a vehicle according to an embodiment of the invention;

FIG. 4 is cut-away top view of part of a vehicle according to an embodiment of the invention;

FIG. 5 is cut-away top view of part of a vehicle according to an embodiment of the invention; and

FIG. 6 is top view of part of a vehicle according to an embodiment of the invention;

### DETAILED DESCRIPTION

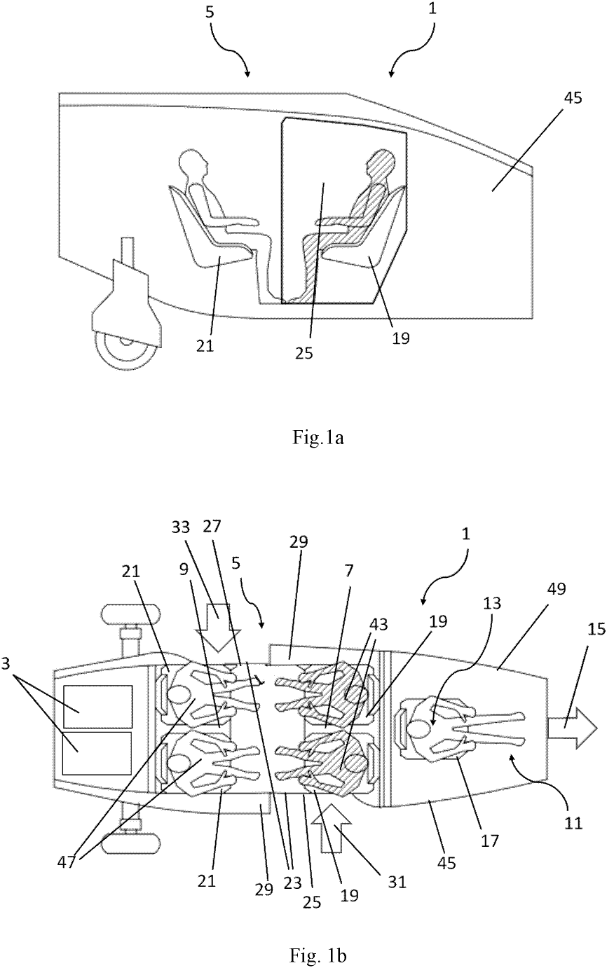

With reference to FIGS. 1a-d, a part of a vehicle is shown. In this case the vehicle is a vtol aerial taxi aircraft 1. The aircraft 1 comprises a plurality of electrically powered rotors (not shown) for propulsion. The rotors are tilt-rotors, which facilitate both vertical and conventional flight. Electrical power for the rotors is provided by batteries 3, though in other embodiments alternatives may be used such as one or more hydrogen fuel cells.

The aircraft comprises a portion (generally shown at 5) having first and second occupant zones (respectively generally shown at 7 and 9) and a cockpit (generally shown at 11) having a vehicle operator zone (generally shown at 13).

The vehicle operator zone 13 is centrally located within the aircraft 1 with respect to a direction that is perpendicular to a conventional direction of travel 15 of the aircraft 1 during conventional flight. Specifically, a pilot seat 17 of the cockpit 11 is centrally mounted within the cockpit 11 in terms of its port to starboard positioning.

The portion 5 is in this embodiment a passenger cabin which defines an enclosed space in which the first 7 and second 9 occupant zones are provided. The portion 5 is substantially cuboid in shape. Inside the portion 5, occupant zones (in this case limited to the first 7 and second 9 occupant zones) are provided in rows. The first 7 and second 9 occupant zones are adjacent rows, with each row running from side to side, that is, in a port to starboard direction. Consequently, the first occupant zone 7 is forward of the second occupant zone 9 in the aircraft 1. The first occupant zone 7 is formed by a pair of first seats 19 (though in other embodiments may comprise any arrangement or quantity of seating or any area arranged to contain and/or to be occupied by one or more users). The second 9 occupant zone 9 is formed by a pair of second seats 21 (though in other embodiments may comprise any arrangement or quantity of seating or any area arranged to contain and/or to be occupied by one or more users). In the embodiment of FIGS. 1a-d, the first 7 and second 9 occupant zones are arranged so that the first seats 19 face the second seats 21. The first 7 and second 9 occupant zones are of substantially the same configuration in that they are of similar size, shape and layout, differing substantially only in the direction in which the first 19 and second 21 seats face.

The portion 5 also comprises access points 23 arranged for user ingress into the portion 5 and indeed into the aircraft 1. In the embodiment of FIGS. 1a-d, the portion 5 has only two access points 23, a first access point 25 and a second access point 27. The first 25 and second 27 access points are provided on opposite side walls 29 of the aircraft 1 as apertures within those side walls 29. A direction of ingress 31 through the first access point 25 is substantially opposed to the direction of ingress 33 through the second access point 27. Each of the first 25 and second 27 access points provide restricted head height access to and from the interior of the portion 5 (i.e. the passenger cabin).

Each access point 23 of the portion 5 is positionally asymmetric with all opposing access points 23 of the portion. Thus, it may be that the centroids of all opposing apertures are misaligned with each other. In the case of the FIGS. 1a-1d embodiment, the first access point 25 and second access point 27 are therefore positionally asymmetric. Two vectors respectively passing through the centroids of the apertures, each travelling towards the opposed side of the portion 5 and in directions parallel to the main direction of entry through the respective aperture, (in this case directions perpendicular to the conventional direction of travel 15 of the aircraft 1 during conventional flight) do not meet. Indeed, in the case of the first 25 and second 27 access points, the asymmetry is sufficient such that there is no overlap in projections of the respective apertures towards the opposed side of the portion 5 and in directions parallel to the main direction of entry through that aperture (in this case directions perpendicular to the conventional direction of travel 15 of the aircraft 1 during conventional flight).

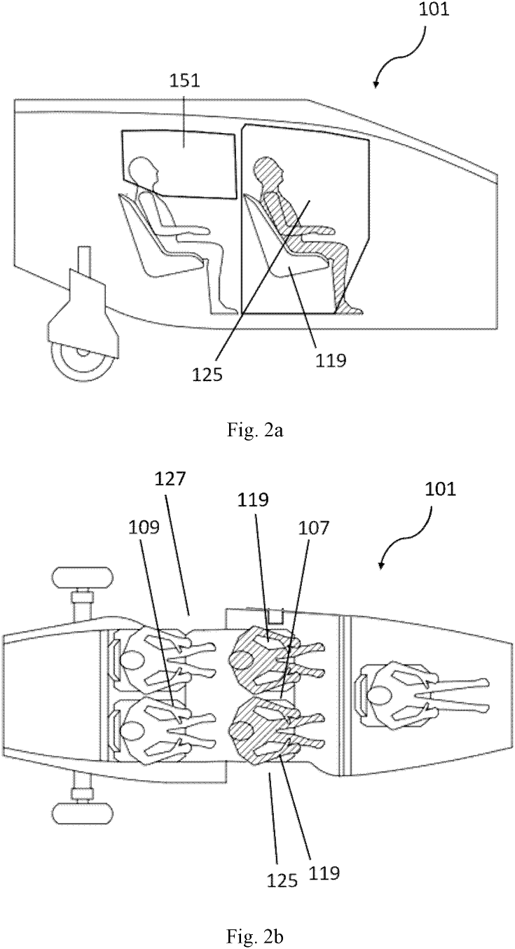

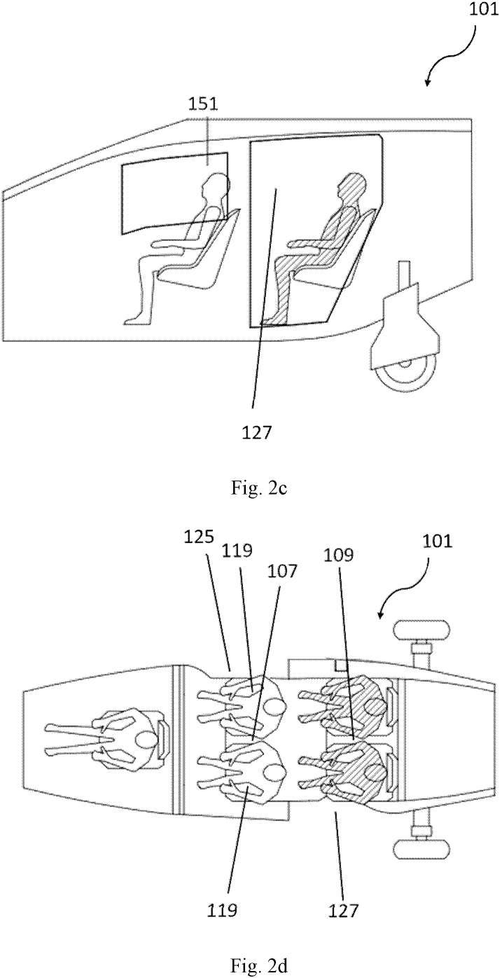

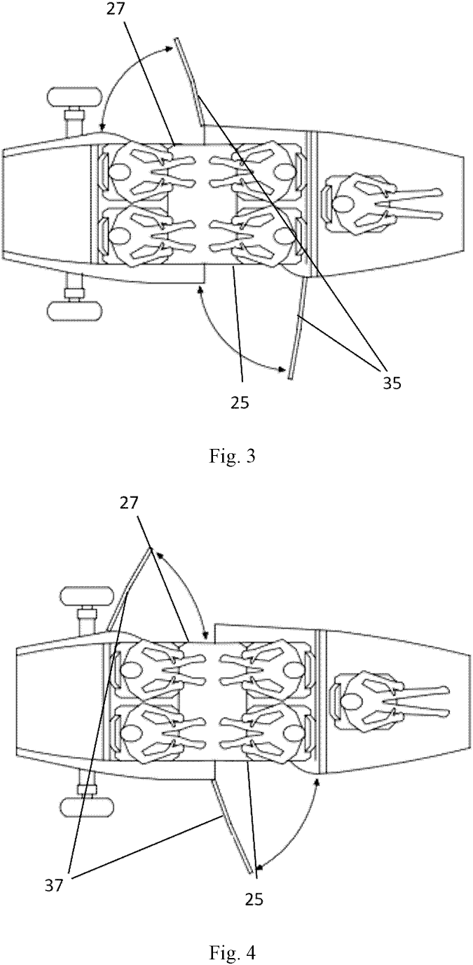

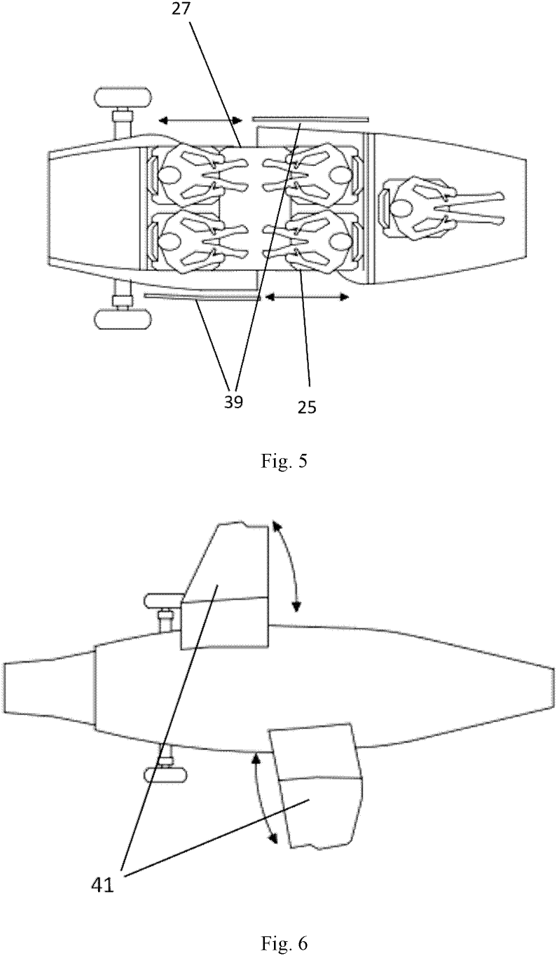

Each of the first 25 and second 27 access points is provided with a door. For simplicity, the doors are not shown in FIGS. 1a-d, but various possible configurations are shown in FIGS. 3-6. FIG. 3 shows each of the first 25 and second 27 access points with one forward hinged (i.e. conventional) door 35. FIG. 4 shows each of the first 25 and second 27 access points with one rear hinged (i.e. suicide) door 37. FIG. 5 shows each of the first 25 and second 27 access points with one sliding door 39. In the example of FIG. 5, the sliding door for the first access point 25 slides forwards to close whilst the sliding door for the second access point 27 slides rearwards to close, though alternatives are possible. FIG. 6 shows each of the first 25 and second 27 access points with one roof-hinged (i.e. gull-wing) door 41.

The first occupant zone 7 is preferentially accessed by user ingress from the first access point 25. Meanwhile, second occupant zone 9 is preferentially accessed by user ingress from the second access point 27. In the case of the embodiment of FIGS. 1a-d, various factors contribute to this, each being sufficient alone to achieve the preference, but in combination, strengthening it. First, the first occupant zone 7 is the nearest occupant zone to the first access point 25 and the second occupant zone 9 is the nearest occupant zone to the second access point 27. That is, the nearest part of the first occupant zone 7 to the first access point 25 is nearer to the first access point 25 than the nearest part of the second occupant zone 9 and the nearest part of the second occupant zone 9 to the second access point 27 is nearer to the second access point 27 than the nearest part of the first occupant zone 7 to the first occupant zone 7. Further, the first occupant zone 7 is substantially positionally aligned with the first access point 25 and the second occupant zone 9 is substantially positionally aligned with the second access point 27. Furthermore, the direction of ingress 31 through the first access point and the direction of ingress 33 through the second access point is parallel to the row direction of the first 7 and second 9 occupant zones.

In exemplary use of the aircraft 1, the aircraft 1 may land for passenger embarkation (and optional preceding passenger disembarkation as appropriate). The facility for a relatively rapid turnaround (i.e. landing, disembarkation of any passengers, embarkation of new passengers and take-off) may be desirable, especially where the aircraft 1 is operating as a taxi. At least while passenger embarkation occurs, the aircraft rotors may be in a vertical flight configuration and/or may be static. In this way, obstacles and potential dangers for passenger embarkation may be reduced. The static state of the rotors may be facilitated without significantly compromising turnaround time by relatively rapid shut-down and start-up characteristics afforded by the electric propulsion. This may compare favourably with (for instance) a gas turbine powered helicopter, which, due to relatively slow shut-down and start-up times for its engine(s) may be compromised in turnaround time if the rotors are not kept turning.

Passenger boarding of the aircraft 1 from both sides is possible given its configuration. The central location of a pilot seated in the pilot seat 17 may facilitate monitoring of passenger boarding to both sides of the aircraft 1. In the present example, two passengers approach each side of the portion 5, two first users 43 approaching the starboard side 45 and two second users 47 approaching the port side 49. The staggering of the first 25 and second 27 access points and their positional and orientational relationship with the first 7 and second 9 occupant zones, mean that during simultaneous boarding from both the starboard 45 and port 49 sides, the users 43 and 47 need not find themselves in opposition, and may naturally occupy the occupant zones corresponding to their respective entry points. Thus specifically, a first of the first users 43 may ingress through the first access point 25 in a direction that is perpendicular to a conventional direction of travel 15 of the aircraft during conventional flight. In doing so, the first of the first users 43 will find herself/himself nearest to and aligned with the first occupant zone 7 and travelling in a direction aligned with the row direction of the first occupant zone 7. She/he may naturally therefore select to occupy the first occupant zone 7, especially where one of the second users 47 is substantially simultaneously boarding through the second access point 27 and thereby tending to impeded access to the second occupant zone 9. Further, and at least to the extent that the first of the first users 43 is aware of a second of the first users 43, the first user may tend to traverse to the port side 49 of the first occupant zone 25 and occupy the seat of the first occupant zone 25 nearest to the port side 49 of the aircraft 1. As will be appreciated, these factors and processes may be repeated by the second users 47 approaching the port side 49 in occupying the second occupant zone 27 of the aircraft 1 mutatis mutandis.

As will be appreciated, the possibility remains for the first 43 and second 47 users to deviate from the boarding procedure outlined above and/or to subsequently re-arrange their seating positions. Nonetheless, the configuration of the aircraft 1 in the manner described above may at least allow for more intuitive and rapid boarding than would be possible with a conventional single access point or conventional positionally symmetric access points.

During disembarkation, the embarkation process may be reversed by the first 43 and second 47 users and in doing so, delays and/or confusion may again be reduced/avoided.

As will be appreciated, in the event that it were to be desirable/necessary, both the first 7 and second 9 access points are ultimately available for disembarkation by any and optionally all of the first 43 and second 47 users. Thus, particularly in the event of an emergency, the most appropriate egress side may be selected for/by each passenger.

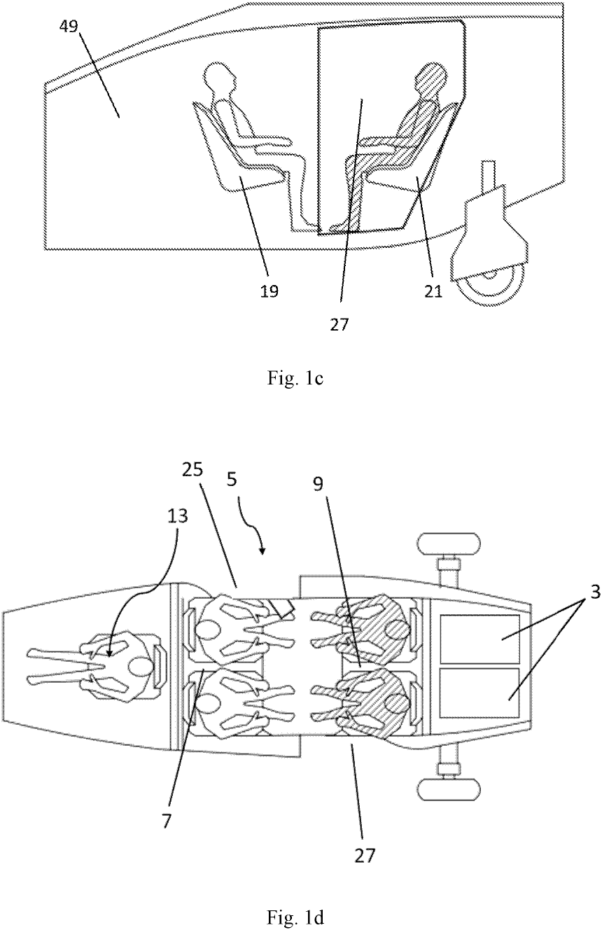

Referring now to FIGS. 2a-2d an aircraft 101 is shown, which is similar to the aircraft 1 of the embodiment shown in FIGS. 1a-1d. The difference between the embodiments is that in the aircraft 101, the seating in first 107 and second 109 occupant zones is configured to face in the same direction (in this case forwards with respect to the aircraft 101). Otherwise the aircraft 101 and a possible embarkation procedure therefor are substantially identical with that of aircraft 1 described above. The differences are that users preferentially accessing the first occupant zone 107 and a pair of first seats 119 therein via a first access point 125, may be significantly encumbered and/or prevented from accessing the second occupant zone 109 via the first access point 125 by seat backs of the pair of first seats 119. Similarly, users preferentially accessing the second occupant zone 109 via a second access point 127, may be significantly encumbered and/or prevented from accessing the first occupant zone 107 by the backs of the pair of first seats 119. Consequently, the desirability/necessity of accessing of the first occupant zone 107 by the first access point 125 and the accessing of the second occupant zone 109 by the second access point may be remain apparent and may be further enhanced.

Additionally, because each user might otherwise, when occupying the portion 5, have only one access point readily available for egress, two emergency egress facilities are provided, one substantially opposite the first access point 125, and one substantially opposite the second access point 127. The emergency egress facilities comprise pop-out windows 151, which may be removed in the event of emergency and egress from the aircraft 1 completed therethrough.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1-21. (canceled)

22. A portion of a vehicle comprising occupant zones in rows, wherein a first of the occupant zones and a second of the occupant zones are adjacent rows and the portion of the vehicle further comprises access points arranged for user ingress into the vehicle, wherein each access point is located so as to be positionally asymmetric with all opposing access points of the portion, and where further the access points comprise a first access point and a second access point located about the portion such that the direction of ingress through the first access point is substantially opposed to the direction of ingress through the second access point and the first occupant zone is the nearest occupant zone to the first access point and the second occupant zone is the nearest occupant zone to the second access point and where further, the portion is arranged for the first occupant zone to be accessed by user ingress from the first access point, and for the second occupant zone to be accessed by user ingress from the second access point.

23. A portion according to claim 22 where the first occupant zone is substantially positionally aligned with the first access point.

24. A portion according to claim 22 where the direction of ingress through the first access point is non-perpendicular with respect to a row direction of the first and second occupant zones.

25. A portion according to claim 22 where the direction of ingress through the first access point is substantially parallel to a row direction of the first and second occupant zones.

26. A portion according to claim 22 where the first occupant zone and second occupant zone are positioned so that one is forward of the other in the vehicle.

27. A portion according to claim 22 where the first occupant zone and the second occupant zone are of substantially the same configuration.

28. A portion according to claim 22 where the first occupant zone comprises a seating area.

29. A portion according to claim 22 where seating in the first occupant zone is configured to face seating in the second occupant zone and the seating in the second occupant zone is configured to face the seating in the first occupant zone.

30. A portion according to claim 22 where the first and the second access points are the only access points arranged for user ingress of the portion.

31. A portion according to claim 22 where the portion comprises all of the access points arranged for user ingress of the vehicle.

32. A portion according to claim 22 where the portion defines an enclosed space in which the first and second occupant zones are provided.

33. A portion according to claim 22 where the portion provides a common space in which the first and second occupant zones are provided.

34. A portion according to claim 22 where the vehicle has a vehicle operator zone which is centrally located within the vehicle with respect to a direction that is perpendicular to a conventional direction of travel of the vehicle during conventional flight.

35. A portion according to claim 22 where the vehicle is an aircraft.

36. A portion according to claim 35 where the aircraft is of a tilt rotor configuration.

37. A portion according to claim 22 where the aircraft propulsion is electrically powered.

38. A vehicle comprising the portion according to claim 22.

39. A method of user vehicle ingress, the vehicle comprising a portion of the vehicle having occupant zones in rows, wherein a first of the occupant zones and a second of the occupant zones are adjacent rows and the portion of the vehicle further comprises access points arranged for user ingress into the vehicle, wherein each access point is located so as to be positionally asymmetric with all opposing access points of the portion and where further the access points comprise a first access point and a second access point, the method comprising:
i) at least one first user ingress into the vehicle through the first access point in a direction substantially opposed to a direction in which at least one second user would ingress the vehicle through the second access point; and
ii) the at least one first user accessing the first occupant zone, which is the nearest occupant zone to the first access point, rather than accessing the second occupant zone, which is the nearest occupant zone to the second access point.

40. A method according to claim 39 further comprising:
iii) at least one second user ingress into the vehicle through the second access point in a direction substantially opposed to the direction in which the at least one first user vehicle ingress through the first access point occurs; and
iv) the at least one second user accesses the second occupant zone, rather than accessing the first occupant zone.

41. A method according to claim 40 where the ingress of at least one of the at least one first user and the ingress of at least one of the at least one second user occurs substantially simultaneous.
